(19) United States
(12) Patent Application Publication
(10) Pub. No.: US 2023/0062929 A1
(43) Pub. Date: Mar. 2, 2023

(54) SYSTEM AND METHOD FOR NET PROMOTER SCORE PREDICTION

(71) Applicant: NICE Ltd., Ra’anana (IL)

(72) Inventors: Advait SAMANT, Pune (IN); Kundan JHA, Pune (IN); Praver CHAWLA, Pune (IN); Sumit VASHISTHA, Puna (IN)

(73) Assignee: NICE Ltd., Ra’anana (IL)

(21) Appl. No.: 17/464,040

(22) Filed: Sep. 1, 2021

(51) Int. Cl. G06Q 30/02

(52) U.S. Cl. CPC G06Q 30/0203; G06Q 30/0201

(57) ABSTRACT

A system and method for generating response data statistics by for example, receiving response data items, each including an associated score measuring the likelihood of a user to recommend. For each data item, if the associated score is null a historical score may be used as the associated score. The response data item may then be categorized into groups based on the associated scores and a ratio of the number of response data items in a group to the total number of response data items may be calculated. Generated data may be displayed for each group.

### FIELD OF THE INVENTION

The present invention relates generally to analyzing survey data, for example providing a predictive determination of a net promoter score (e.g., recommendation) of survey respondents.

### BACKGROUND OF THE INVENTION

Customer loyalty to a product, business, company, or service is determined by a variety of methods. For example, companies often conduct research surveys through various survey channels (e.g. interactive voice response (IVR), short message service (SMS), email invitation, at the conclusion of a purchase, or at the end of a customer service interaction, etc.), in order to receive respondent data from a survey respondent based on their choice to recommend the product, service or business to other friends or colleagues of business. Typically, this is a scaled question which has to be responded on a scored scale of for example 0 (not at all likely) to 10 (extremely likely). Other scales may be used.

Companies may utilize this respondent data and a variety of resources to then assess the thoughts, opinions, and feelings of their customers regarding the company's products, business, and/or services. Respondent data may be used to assess areas where companies might need improvement, make decisions regarding a product direction, or in general to evoke discussion of key topics.

Often, a company may repeatedly invite individuals (e.g. survey respondents) to participate in a survey or different surveys. Survey respondents, however, seldom respond to the survey (e.g. non-respondent) or may only participate in the survey sparingly. As a result of the limited (e.g. shortfall of) responses to the surveys, this shortfall of respondent data can potentially lead to an incorrect representation of the actual data and may therefore lead to interpretations which provide an inaccurate insight of actual respondent sentiment. For example, in a typical scenario, survey respondents with a negative sentiment (e.g. scores of for example, 0-6) may be more likely to repeatedly respond to surveys to express their dissatisfaction whereas respondents with a positive sentiment may be relatively less likely to respond repeatedly to different surveys.

Therefore, it may be desirable for a system and method to comparatively analyze non-respondent data in order to provide a more accurate insight of actual data.

### SUMMARY OF THE INVENTION

A system and method may generate response data statistics by for example, receiving response data items, each including an associated score measuring the likelihood of a user to recommend. For each data item, if the associated score is null (e.g. empty or no data; e.g. in the case that the recipient did not respond), a historical score may be used as the associated score, the historical score being for example a score associated with a previous response data item generated by the user of the response data item. The response data item may then be categorized into groups based on the associated scores wherein for each group, the ratio of the number of response data items in a group to the total number of response data items may be calculated. Generated data, such as the ratios may then be displayed for each group. Based on the generated data, customers may take proactive action around areas they may need to continue to focus on and areas where improvements are needed.

Embodiments may improve prior response data statistics and respondent data analysis technology, and may provide a technology solution which may for example combine an associated score with a historical score (e.g. past associated score) to enable an institution to comparatively analyze respondent data and provide a more accurate representation of the respondent data.

A system and method may enable incorporation of past response data into response data statistics.

### BRIEF DESCRIPTION OF THE DRAWINGS

Non-limiting examples of embodiments of the disclosure are described below with reference to figures listed below. The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings.

FIG. 1 depicts a high-level block diagram of an exemplary computing device according to some embodiments of the present invention.

FIG. 2 depicts a system for respondent data analytics according to embodiments of the present invention.

FIG. 3 depicts an example calculation for a net promoter score on actual respondent data according to embodiments of the present invention.

FIG. 4 depicts an example display for an actual net promoter score according to embodiments of the present invention.

FIG. 5 depicts an example display for an anticipated net promoter score according to embodiments of the present invention.

FIG. 6 depicts an example calculation for a predicted net promoter score on actual and historical respondent data according to embodiments of the present invention.

FIG. 7 depicts an example display for a predicted net promoter score according to embodiments of the present invention.

FIG. 8 depicts a flow diagram for categorizing the associated score according to embodiments of the present invention.

FIG. 9 depicts an example display for a survey question according to embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

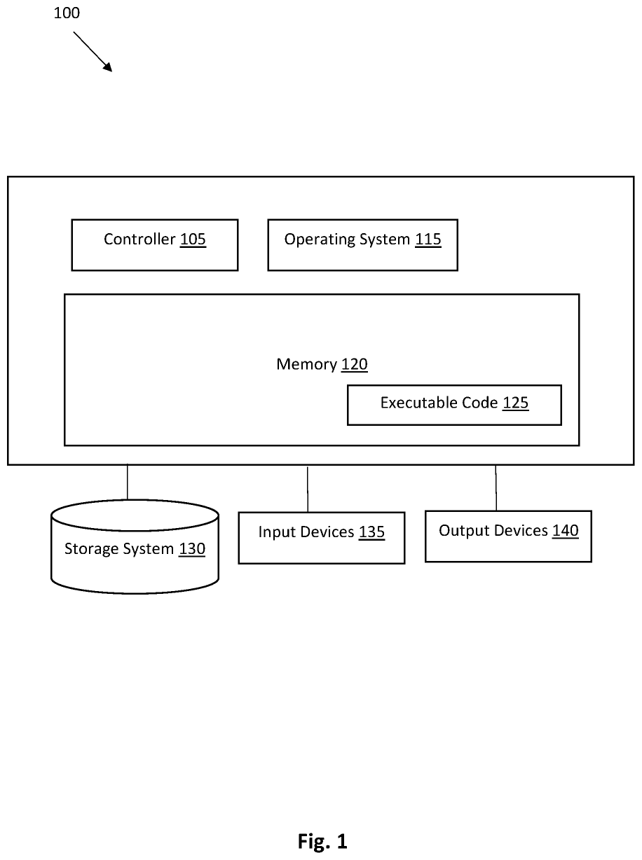

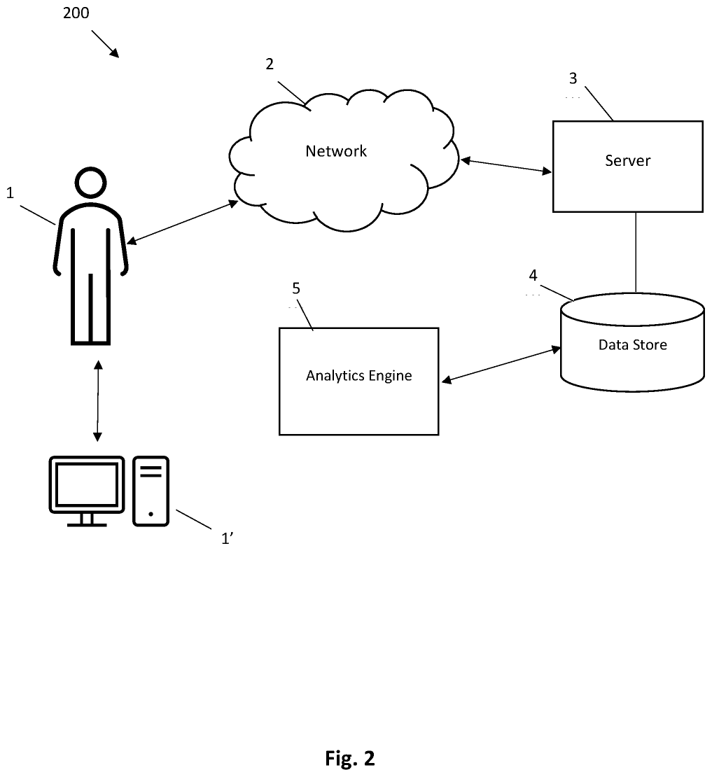

Reference is made to FIG. 1, showing a high-level block diagram of an exemplary computing device according to some embodiments of the present invention. Computing device 100 may include a controller 105 that may be, for example, a central processing unit processor (CPU) or any other suitable multi-purpose or specific processors or controllers, a chip or any suitable computing or computational device, an operating system 115, a memory 120, executable code 125, a storage system 130, input devices 135 and output devices 140. Controller 105 (or one or more controllers or processors, possibly across multiple units or devices) may be configured to carry out methods described herein, and/or to execute or act as the various modules, units, etc. for example when executing code 125. More than one computing device 100 may be included in, and one or more computing devices 100 may be, or act as the components of, a system according to embodiments of the invention. Various components, computers, and modules of FIG. 1 may be or include devices such as computing device 100, and one or more devices such as computing device 100 may carry out functions or be devices such as those described FIG. 2 and produce displays as described herein.

Operating system 115 may be or may include any code segment (e.g., one similar to executable code 125) designed and/or configured to perform tasks involving coordination, scheduling, arbitration, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may configure controller 105 to calculate and display respondent data and perform other methods as described herein. A system according to some embodiments of the invention may include a plurality of executable code 125 that may be loaded into memory 120 or another non-transitory storage medium and cause controller 105, when executing code 125, to carry out methods described herein.

Storage system 130 may be or may include, for example, a hard disk drive, a CD-Recordable (CD-R) drive, a Blu-ray disk (BD), a universal serial bus (USB) device or other suitable removable and/or fixed storage unit. Data such as user data, survey response data, and survey invitations, may be stored in storage system 130 and may be loaded from storage system 130 into memory 120 where it may be processed by controller 105. For example, memory 120 may be a non-volatile memory having the storage capacity of storage system 130. Accordingly, although shown as a separate component, storage system 130 may be embedded or included in memory 120.

Input devices 135 may be or may include a mouse, a keyboard, a microphone, a touch screen or pad or any suitable input device. Any suitable number of input devices may be operatively connected to computing device 100 as shown by block 135. Output devices 140 may include one or more displays or monitors, speakers and/or any other suitable output devices. Any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a printer, a universal serial bus (USB) device or external hard drive may be included in input devices 135 and/or output devices 140.

In some embodiments, device 100 may include or may be, for example, a personal computer, a desktop computer, a laptop computer, a workstation, a server computer, a network device, or any other suitable computing device. A system as described herein may include one or more devices such as computing device 100.

Reference is now made to FIG. 2 depicting a system 200 for response data analytics according to embodiments of the present invention. Some of the components of FIG. 2 may be separate computing devices such as servers and others may be combined into one computing device. As shown, system 200 may include a pollster or server 3 that may be any suitable computing device (e.g. network server). As shown, pollster or server 3 may transmit surveys to (e.g. invitation) or receive surveys from end user 1, e.g. electronically via computer network 2. A survey, as herein described, refers to a set of questions being asked to an end user (e.g. customer), typically based on certain completed actions, for example, buying a product or connecting with a contact center service for any issues, for recommendations, etc. Various completed actions may trigger the request for a survey by a pollster. For example, at the end of an online live chat session with a customer service representative, a survey prompt may appear, e.g. on a computing device 1′ operated by an end user to ask the customer their satisfaction with said representative.

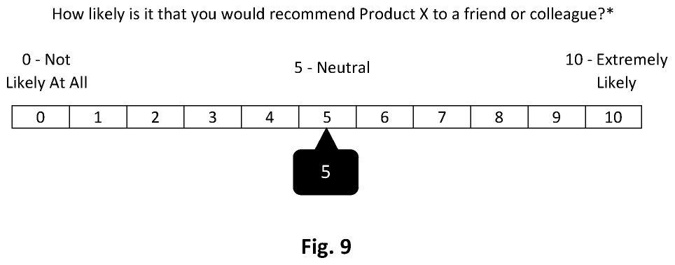

Turning briefly to FIG. 9, an example display is provided depicting a survey question according to embodiments of the present invention. In FIG. 9, a survey question “How likely is it that you would recommend Product X to a friend or a colleague?” is asked to an end user. An end user may respond with a score from 0-10 selecting their level of satisfaction with said product X. Surveys may be sent or distributed periodically or randomly to an end user 1 through various mediums (e.g. IVR, SMS, email, etc.), for a business to gauge an end user's sentiment with the business' product, service, etc. For example, an internet service provider (ISP) may on a monthly periodic basis transmit survey invites regarding the ISP provider's internet service performance. Such an example survey may contain questions regarding a consumer's satisfaction with internet speed, customer service, or content variety. Customers who have had good experiences may provide a positive review and give high scores and customers who have had recurrent problems may provide relatively low or negative scores. These scores may be recorded as response data and transmitted to the pollster for analysis. Surveys may also include open-ended qualitative text data related to the survey questions. For example, surveys may include an optional text box for open-ended input for end users to provide additional comments or thoughts, categorizations, or sentiments. The open-ended questions may help verify that a respondent's score correlates with their sentiment provided in the open-ended qualitative text input. For example, on a scale of 0-10, a score of 10 should have in the text of the open-ended qualitative data, a positive sentiment. This may be verified, by for example, various forms of natural language processing on the text data (e.g. opinion mining). Surveys may have an expiration date or a valid time window, for example, a survey may have a certain time window in which responses are valid and accepted. If an invitation to participate in a survey is outside of the valid time window, the survey may be no longer be accepted or considered. The time window or expiration of surveys may be configurable or be adjusted by the creator of the survey.

Returning to FIG. 2, pollster or server 3 may send a survey through network 2 to end user 1. Computer or terminal 1′ may be operated by end user 1, communicating with server 3, to display data (e.g. surveys) to end user 1 and the receive input from end user 1. Network 2 may be, may include or may be part of a private or public IP network, the internet, or a combination thereof. For example, network 2 may be or may comprise of a global system for mobile communications (GSM) network or any numerous elements/mediums of network (e.g. telephone, email, mail). Surveys may be sent across omni channel networks, for example, such as a short messaging service (SMS), an email link, and/or an interactive voice response (IVR). It will be recognized that embodiments of the invention are not limited by the nature of network 2, surveys may be sent in various mediums and collected through various mediums.

In an exemplary scenario, pollster or server 3 may be part of a business which sells a service or product, and sends or distribute surveys to an end user or respondent 1 (e.g. by network 2) regarding the end user's satisfaction with the business' services and/or product. A survey respondent may be any individual who has received a survey through any survey medium. For example, a survey may be submitted by email, mail-in letters, verbally, etc. Survey respondent or end user 1 may be notified of the survey and may or may not choose to respond to the survey (e.g. fill out the survey or choose to ignore the survey). The completed survey or response data item from end user 1 may be then sent to network 2 and then retrieved by server 3. The response data item may include an associated score, measuring the likelihood of a user to recommend a survey product, business, or service. For example, users may be asked if the user likes a certain product or is satisfied with a customer service experience, the associated score may therefore reflect the user's likelihood to recommend such a product or service. Typically this is a scaled question which has to be responded to on a scale for example of 0 (not at all likely) to 10 (extremely likely). The response data item may include a person's unique identifier which may be used to track the end user 1 who which completed the response data item. A person's unique identifier may be constant identifier across multiple surveys and be a unique numeric sequence, an end user's email address, phone number, account number, order number, etc., or any unique identifier as defined by the creator of the survey. Server 3 may then store the collected response data items and the person's unique identifier from end user 1 and store in data store 4. Data store 4 may then send the response data item to analytics engine 5 to be analyzed. For example, a business may transmit an email survey to end user 1 (e.g. to the computer operated by the user such as depicted in FIG. 1) with a clickable link in the body of the email message, displayed on the computer operated by the user. The link may lead to a web-browser (e.g. executed by the computer) window prompt with multiple questions, each question with a selectable score ranging from for example 0-10. An end user may respond to the survey, for example, by filling out his/her contact information and selecting a score for each of the questions. This respondent data is then transmitted from the user-operated computer to the pollster (e.g. a server).

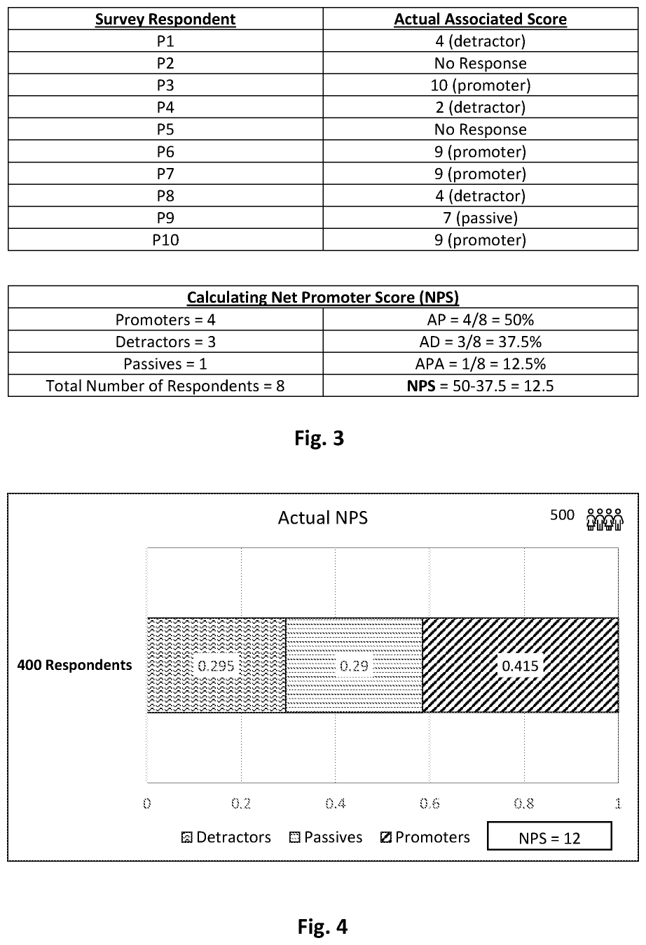

Reference is now made to FIG. 3, which shows an example calculation of actual net promoter score according to embodiments of the current invention. The calculation may be done by, for example, the analytics engine 5. “Actual” in this sense may describe the current, present, or the most recent response data available. For example, any surveys that were distributed to end users 1 and then responded to during a valid and most recent time window may be considered “actual”. As an example, assume that for a product, there are product research surveys conducted every month beginning on the 1^{st} of the month, the “actual” time window may therefore refer to the most recent month starting from the 1^{st} of the month to the current date. A net promoter score, as described herein, is a score calculated on the basis of recommendation given by the survey respondents (e.g. end users that responded to the survey). For example, a response data item received from an end user 1 (e.g. survey) may be associated with a score ranging from 0-10, with 0 being least likely to recommend and 10 being most likely to recommend. Other score ranges may be used. A survey may contain multiple survey questions, each with a score. The scores for each of the questions may be aggregated or averaged to provide the associated score for the response data item. For example, a response data item (e.g. survey response) may have an associated score determined from the average of three scores from three questions answered by a respondent. For example, a respondent answered three questions Q1, Q2, and Q3 with scores 7, 8, and 9, respectively. The associated score for the response data item is therefore an average (7+8+9)/3=7.

The response data item may then be categorized or grouped based on the score value and tallied. For example, the response data item may be categorized or marked as a “promoter”, wherein the associated score of the response data item is high (e.g. 9-10), indicating positive sentiment. A promoter may be a person who is positive about a product or service they have used; or may be a response to a survey that is positive about a product or service the respondent used. “Promoters” may be people who are likely to recommend a product or service to friends or associates and in speak in high regard of said product or service. The response data item may be categorized as a “detractor”, wherein the associated score of the response data item is low (e.g. 0-6) indicating negative sentiment. A “detractor” may be a person who is negative about a product or service they have used, expressing dissatisfaction; a detractor may also be a response by such a person. A person who is considered a “detractor”, may, in severe cases, through one's own volition, proliferate their dissatisfaction of a product or service to their friends, families, or associates. For associated scores between these ranges (e.g. 7-8), it may be categorized as “passive”, indicating a neutral sentiment. A “passive” person does not have a leaning opinion, feeling an indifference towards the product or service. A person may be considered passive if the person is simply satisfied with the product or service, feeling no affinity towards positivity or negativity; a passive response may be made by such a person. It will be understood that the scores need not be limited to type, range, scale, or format. Scores may be of any format suitable for response by an end user. For example, a qualitative question may be ‘scored’ and be represented in an integer format such as an integer from a scale of 1-100. In some embodiments, scores may be negative, for example, a score may be placed on a continuous scale ranging from −1 to 1, with −1 indicating a strong “disagree” and a 1 indicating a strong “agree”. The associated scores ranging from 0-10 are merely examples according to one embodiment of the invention, but scores are not limited in this regard. Scores may be integrated from scale to scale. For example, a score with a first range may be converted to a second by normalizing the respective scale. For example, scores from 1-5 may be normalized to a scale of 0-10 by mapping a first score from a first range to a second score from a second range. An example mapping for the preceding example is shown below in table 1:

| Score Range 1-5 | Score Range 0-10 |
|---|---|
| 1 | 0 or 1 |
| 2 | 2 or 3 |
| 3 | 4 or 5 or 6 |
| 4 | 7 or 8 |
| 5 | 9 or 10 |

### Table 1

If the scales cannot be integrated, the respondent data may be directly examined and converted. For example, respondent data with positive sentiment may be examined and judgement may be made by a pollster for a corresponding score. Once the scores have been grouped into their respective categories, the associated scores which fall into a certain category may be tallied, or counted. For example, there may a set of associated scores as following; 3, 5, 8, 10, 7. Following the foregoing example, it is evident that the two associated scores of 3 and 5 fall under detractor category, 8 and 10 fall under the promoter category, and 7 falls under the passive category. Therefore, the tallies are: detractor: 2, promoter: 2, passive: 1.

A NPS may help companies take proactive action around areas they may need to continue to focus on and areas where they need improvement. Correlating NPS respondent data with other open-ended qualitative survey questions data like comments, categorization, or sentiments, may help to filter out false positives. For example, a high NPS score for a survey respondent may be verified by a comment section at the end of the survey where an end user may write their thoughts or opinions in natural language. NPS may help companies to know the direction of growth and general trends that may be occurring, allowing for decisions to proactively close the loop between the business and the customer. For example, the respondent data and NPS statistics may help companies find if certain staff needs to be trained on certain aspect of their job. A root cause analysis may be performed on downtrends associated with the NPS. NPS may help companies discover if structural changes in the organization are needed. NPS may also be an important statistic in case studies, for example, a case study may be performed on how to move customers in the detractors and passives bucket, based on historical and current data, to a promoter bucket. These statistics may be helpful for companies to rally around NPS trends and bring awareness to the situation between the company and their customers, stressing the importance of what needs to be focused on.

Returning to FIG. 3, following the grouping and tallying of the associated scores, to calculate the net promoter score, the number of “detractors” are subtracted from the number of “promoters”, expressed as a percentage or ratio of the total number of respondents. A net promoter score calculation is shown in example Formula 1 below (other formulas may be used):

% of Actual Promoters (AP)=Number of Promoters/Total Number of Respondents

% of Actual Detractors (AD)=Number of Detractors/Total Number of Respondents

% of Actual Passives (APA)=Number of Passives/Total Number of Respondents

Net Promoter Score (NPS)=AP−AD

### Formula 1

In FIG. 3, an example set of respondent data items is provided showing the data calculation where 10 uniquely identified people (P1-P10) have been invited to a survey, of which 8 responded, the total number of respondents is therefore 8. Of the ten uniquely identified people, it can be seen that a ratio of 3 out of the 8 (AD=37.5%) total number of respondents responded negatively (e.g. associated score of 0-6, “detractor”), a ratio of 4 out of the 8 (AP=50%) total number of respondents responded positively (e.g. associated score of 9-10, “promoter”), and a ratio of 1 out of the 8 (APA=12.5%) number of respondents responded neutrally (e.g. associated score of 7-8, “passive”). According to Formula 1, the actual net promoter score is therefore (50%−37.5%=12.5).

In FIG. 4, an example display is provided for an actual net promoter score according to embodiments of the present invention. To illustrate embodiments of the invention, FIG. 4 uses arbitrary values for the sake of demonstration. In FIG. 4, five hundred total invitations for surveys have been sent out to end user 1 (e.g. by server 3 through network 2). Of the five hundred total invitations, only 400 respondents responded (e.g. response data items). Of the 400 respondents, an arbitrary 166 respondents responded positively (e.g. promoters), 118 responded negatively (e.g. detractors), and 116 responded neutrally (e.g. passives). A net promoter score may be calculated for the foregoing example according to Formula 1; the % of Actual Promoters is 166/400=41.5%, the % of Actual Detractors is 118/400=29.5%, and the % of Actual Passives is 116/400=29%. The Net Promoter Score is therefore 41.5-29.5=12.

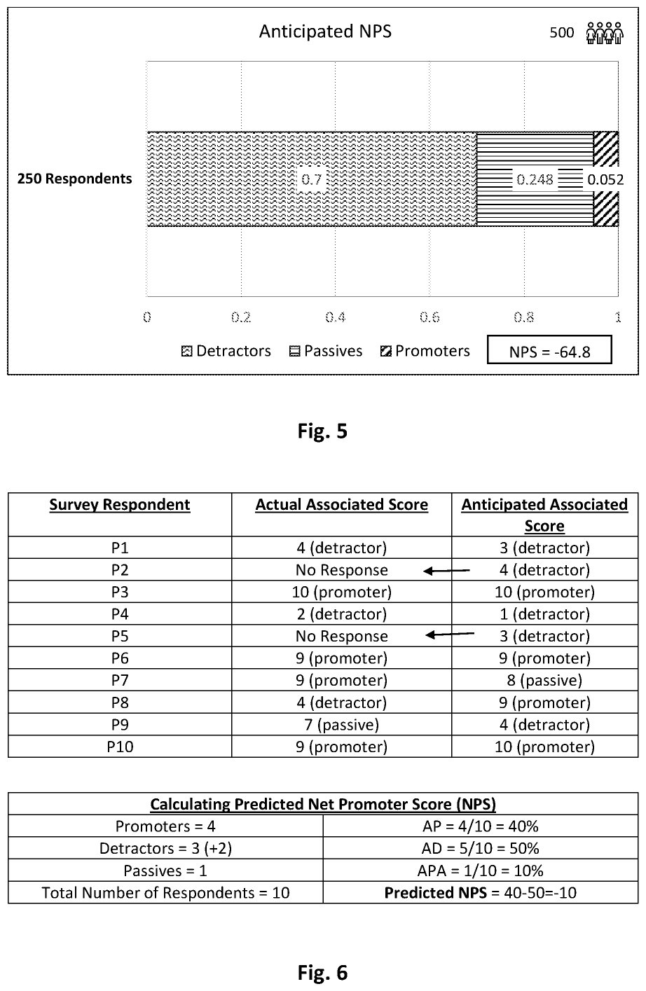

In FIG. 5, an example is provided showing the calculation of an anticipated net promoter score according to embodiments of the present invention. It may be helpful for a net promoter score to “anticipate” an actual net promoter score. “Anticipate” may describe projecting, forecasting, or estimating a net promoter score using historical response data. For example, in an exemplary scenario, a survey may be repeatedly sent to respondents in cyclical annual cycles. It may be helpful to anticipate the current (e.g. actual) year net promoter score using the previous (e.g. historical) year response data items. An anticipated net promoter score calculation is shown in Formula 2 below:

% of Historical Promoters (HP)=Number of Historical Promoters/Total Number of Historical Respondents

% of Historical Detractors (HD)=Number of Historical Detractors/Total Number of Historical Respondents

% of Historical Passives (HPA)=Number of Historical Passives/Total Number of Historical Respondents

Anticipated Net Promoter Score (NPS)=HP−HD

### Formula 2

Formula 2 may be a modification of Formula 1 by changing the source of the response data item to using historical response data, the calculations may be similar. To illustrate embodiments of the invention. FIG. 5 uses arbitrary values for the sake of demonstration. FIG. 5 shows a statistical display for a net promoter score. A total of five hundred invitations for surveys have been sent out during a past historical survey time window to end user 1 (e.g. by server 3 through network 2). Of the five hundred total survey invitations, only 250 respondents responded in the past (e.g. historical response data items). Of the 250 respondents, an arbitrary 13 respondents responded positively (e.g. promoters), 175 responded negatively (e.g. detractors), and 62 responded neutrally (e.g. passives). An anticipated net promoter score may be calculated for the foregoing example according to Formula 2; the % of Historical Promoters is 13/250=5.2%, the % of Historical Detractors is 175/250=70%, and the % of Historical Passives is 62/250=24.8%. The Anticipated Net Promoter Score is therefore 5.2-70=−64.8.

In FIG. 6, an example actual respondent data set (e.g. of FIG. 3) and a set of historical respondent data items is provided showing the data calculations of a predicted net promoter score. A “predicted” net promoter score may combine the response data items from both the actual and anticipated net promoter scores. For example, following the foregoing example of FIG. 3, assume that the survey of FIG. 3 was also distributed to the same ten identified individuals (e.g. P1-P10, identified by their unique person's identifier) during a past survey time window, during which the two respondents who did not respond currently (e.g. P2 and P5 of FIG. 3), but responded in the past. Expressed differently, identified individuals who responded to previous historical surveys but ignored current surveys may have the anticipated associated score substituted for the actual associated score. A predicted net promoter score may substitute previous historical response data items for current response data items if the associated score for the current response data is null. “Previous” may describe any period prior in time to the period of time of the current survey, but typically, the most recent period outside of a valid current survey time window. For example, a person X may have participated in multiple repeated surveys during monthly periods starting from January of the current year. Assuming that each survey period or time window is for only one month, and the current survey period is in the month of July, then the months from January to June may be considered “previous” survey periods. If person X participates in every survey (e.g. January, February, March, April, May. June, July) up to the current period, then the previous period may be the most recent previous period excluding the current period, in this example, the month of June. If for example person X only completes surveys for January. March, April, then the most recent previous period excluding the current period, in this example, is the month of April. Person X's most recent previous period respondent data (e.g. historical associated score) may be used to substitute for the current survey period's respondent data (e.g. actual associated score) if person X does not complete a survey for the current survey period.

Returning to FIG. 6, 10 uniquely identified people (P1-P10) have been invited to a survey, of which 8 responded. The actual associated scores for the individuals that did not respond (e.g. P2 and P5) are therefore null, as P2 and P5 didn't respond to the current survey (e.g. empty data). However, the existence of historical associated scores may be checked for uniquely identified people that have null values for associated scores. As can be seen in FIG. 6, P2 in a previous survey had an associated score of 4 and P5 in a previous survey had an associated score of 3, therefore these numbers may be substituted for the actual associated score of P2 and P5 as indicated by the arrows. The predicted net promoter score may be calculated according to example Formula 3:

Predicted Net Promoter Score (NPS)=(AP+(HP that didn't respond to current survey))−(AD+(HD that didn't respond to current survey))

### Formula 3

According to Formula 3, the number of actual promoters is added to the number of historical promoters, for the detractors, and the passives. The total number of respondents for a predicted NPS is 10 (e.g. 8 respondents+2 past respondents). Of the ten uniquely identified people, it can be seen that 3 actual promoters, plus an additional 2 historical promoter (e.g. HP that didn't respond to current survey), 5 out of the 10 (AD=50%) total number of respondents responded negatively (e.g. associated score of 0-6. “detractor”), 4 plus no additional historical promoters (e.g. HD that didn't respond to current survey) out of the 10 (AP=40%) total number of respondents responded positively (e.g. associated score of 9-10, “promoter”), and 1 out of the 10 (APA=10%) number of respondents responded neutrally (e.g. associated score of 7-8, “passive”). According to Formula 3, the predicted net promoter score is therefore (40-50=−10).

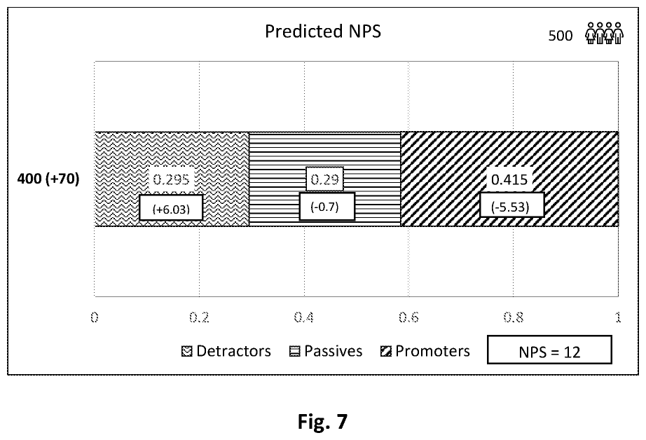

In FIG. 7, an example display is provided for a predicted net promoter score according to embodiments of the present invention. In FIG. 7, five hundred total invitations for surveys have been sent out to five hundred unique end users 1 (e.g. by server 3 through network 2). Of the five hundred total invitations, only 400 respondents responded (e.g. response data items). Of the 400 respondents, an arbitrary 166 respondents responded positively (e.g. promoters), 118 responded negatively (e.g. detractors), and 116 responded neutrally (e.g. passives). These are the same values as FIG. 4. Of the 100 non-respondents (e.g. 500 invitations, 400 respondents), an arbitrary 70 respondents were each found to have completed a survey in the past. Of these 70 respondents, 4 respondents responded positively (e.g. associated score of 9-10, “promoter”), 49 respondents responded negatively (e.g. associated score of 0-6, “detractor”), and 17 respondents responded neutrally (e.g. associated score of 7-8, “passive”). According to Formula 3, the net promoter score may be calculated as by adding the number of promoters to the number of historical promoters (e.g. 166+4 promoters) subtracting the number of detractors and the number of historical detractors (e.g. 118+49). The total number of respondents may be 400 current respondents plus 70 historical respondents for a total of 470 respondents. The % of predicted promoters is (166+4/470)=36.17%, this reflects a 5.53 decrease from the actual. The % of predicted detractors is (118+49/470)=35.53%, which reflects a 6.03 increase from the actual. The % of predicted passives is (116+17/470)=28.3%, which reflects a 0.7 decrease from the actual. These reflecting values showing the ratio difference between the actual score (e.g. without substituting historical scores) and the predicted score may be displayed according to FIG. 7. Said differently, the difference between the ratios calculated by substituting historical values (e.g. predicted) vs. unsubstituted historical values for which the null values are not counted (e.g. actual) may be displayed.

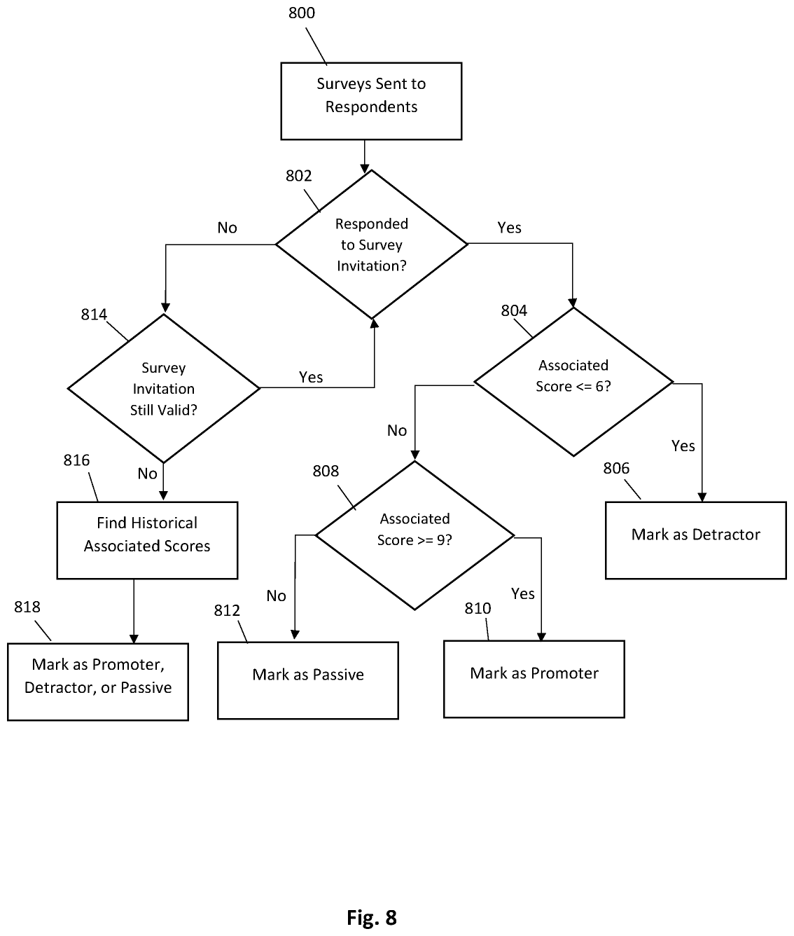

FIG. 8 depicts a flow diagram for categorizing the associated scores according to embodiments of the present invention. At step 800, surveys are sent to respondents (e.g. invitations sent by server 3 through network 2). At step 802, survey respondents are checked to see if they responded to the invitation(s) for a survey. If the invitation for the survey was responded to with respondent data (e.g. survey was properly filled out and delivered within a valid time window), then the data is stored, for example by data storage 4. Analytics engine 5 may then retrieve the stored respondent data and then process a first categorization decision in step 804. In step 804, a first decision is made regarding the associated score of the respondent data. For example, assuming the associated score is between 0-10, with the categorizations of those described in FIG. 3 (e.g. promoter, detractor, passive). Therefore, a decision may be made in step 804 determining whether the associated score is less than or equal to 6, indicating a detractor. If yes, the respondent data is marked or categorized as a detractor in step 806. If the associated score is not less than or equal to 6, then a decision may be made in step 808 determining whether or the not the associated score is greater than or equal to 9. If the associated score is greater than or equal to 9, then the respondent data may be marked a promoter as indicated in step 810. If the associated score is less than 9, then the respondent data is marked as passive in step 812. The marked categorizations may be stored in data storage 4 as an attribute or metadata of the respondent data.

In the situation that the survey respondent did not respond to the survey invitation in step 802, a decision may be made to check the validity of the survey invitation in step 814. If the survey invitation is still valid (e.g. yes in step 814), then the survey is still in progress and the process may continue to wait for a survey respondent's response, the process therefore returns to step 802, waiting for more survey respondents to respond. Once the survey invitation becomes invalid (e.g. no in operation 814) and respondents can no longer respond to the survey, the surveys that were retrieved during the valid survey time window (e.g. retrieved before the survey invitation became invalid), now become historical previous surveys. Historical respondent data may have their categorization data (e.g. associated scores) retrieved (e.g. from data storage 4) and substituted for calculations of NPS in step 816. In some embodiments, historical survey respondent data may not have been categorized beforehand and may be retrieved and marked as promoter, detractor, or passive in step 818 similar to steps 804-812. The categorized respondent data may then be used for substituting associated scores for the calculation of NPS.

Descriptions of embodiments of the invention in the present application are provided by way of example and are not intended to limit the scope of the invention. The described embodiments comprise different features, not all of which are required in all embodiments. Embodiments comprising different combinations of features noted in the described embodiments, will occur to a person having ordinary skill in the art. Some elements described with respect to one embodiment may be combined with features or elements described with respect to other embodiments. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A computer-implemented method for generating response data statistics, the method comprising:
receiving, by a processor, a plurality of response data items each comprising an associated score measuring the likelihood of a user to recommend, wherein for each response data item, if the associated score is null, a historical score is used as the associated score, the historical score being a score associated with a previous response data item generated by the user of the response data item;
categorizing, by the processor, the response data items into groups based on the associated scores;
calculating, by the processor, for each group, the ratio of the number of response data items in a group to the total number of response data items; and
displaying, by the processor, the ratios for each group.

2. The method of claim 1, comprising subtracting, by the processor, the ratio of a first group from the ratio of a second group to determine a net promoter score.

3. The method of claim 1, wherein the historical score is from a most recent period excluding the current period.

4. The method of claim 1, wherein the response data items are associated with a unique person identifier.

5. The method of claim 1, wherein the groups consist at least of: promoter, detractor, and passive.

6. The method of claim 1, wherein the response data item is verified based on an open-ended qualitative text input.

7. The method of claim 1, wherein the displaying the ratios for each group shows a ratio difference between the ratios for each group and the ratios for each group if the null associated scores were not counted.

8. The method of claim 1, wherein the plurality of response data items are triggered based on completed actions.

9. A system for generating response data statistics, the system comprising:
a memory; and
a processor, the processor configured to:
receive a plurality of response data items each comprising an associated score measuring the likelihood of a user to recommend, wherein for each response data item, if the associated score is null, a historical score is used as the associated score, the historical score being a score associated with a previous response data item generated by the user of the response data item;
categorize the response data items into groups based on the associated scores;
calculate for each group, the ratio of the number of response data items in a group to the total number of response data items; and
display the ratios for each group.

10. The system of claim 9, wherein the processor is configured to subtract the ratio of a first group from the ratio of a second group to determine a net promoter score.

11. The system of claim 9, wherein the historical score is from a most recent period excluding the current period.

12. The system of claim 9, wherein the response data items are associated with a unique person identifier.

13. The system of claim 9, wherein the groups consist at least of: promoter, detractor, and passive.

14. The system of claim 9, wherein the response data item is verified based on an open-ended qualitative text input.

15. The system of claim 9, wherein the processor is configured to display the ratios for each group shows a ratio difference between the ratios for each group and the ratios for each group if the null associated scores were not counted.

16. The system of claim 9, wherein the plurality of response data items are triggered based on completed actions.

17. A computer-implemented method for determining a net promoter score, the method comprising:
receiving, by a processor, a plurality of survey responses each associated with a score measuring a user's level of satisfaction, wherein for each survey response, if the associated score is null, a historical score is used as the associated score, the historical score being a score associated with a past survey completed by the user;
grouping, by the processor, the survey response into categories based on the associated scores;
calculating, by the processor, for each group, a ratio of the number of survey responses in a category to the total number of survey responses; and
displaying, by the processor, the ratios for each category.

18. The method of claim 17, comprising subtracting, by the processor, the ratio of a first category from the ratio of a second category to determine a net promoter score.

19. The method of claim 17, wherein the historical score is from a most recent period excluding the current period.

20. The method of claim 17, wherein each of the survey responses are associated with a unique person identifier.
